(19) United States
(12) Patent Application Publication
(10) Pub. No.: US 2013/0342556 A1
(43) Pub. Date: Dec. 26, 2013

(54) CONTROLLING AN APPEARANCE OF AN APPARATUS

(71) Applicants: Johan Kildal, Helsinki (FI); Aleksanteri Heliovaara, Helsinki (FI); Janne Samuli Kuitto, Helsinki (FI); Shengjun Shi, Helsinki (FI); Martina Sabina Frantzen, Helsinki (FI); Kajsa Maria Sundeson, Helsinki (FI); Mikko Kalervo Vuoto, Helsinki (FI)

(72) Inventors: Johan Kildal, Helsinki (FI); Aleksanteri Heliovaara, Helsinki (FI); Janne Samuli Kuitto, Helsinki (FI); Shengjun Shi, Helsinki (FI); Martina Sabina Frantzen, Helsinki (FI); Kajsa Maria Sundeson, Helsinki (FI); Mikko Kalervo Vuoto, Helsinki (FI)

(73) Assignee: Nokia Corporation

(21) Appl. No.: 13/529,408

(22) Filed: Jun. 21, 2012

(51) Int. Cl. G09G 5/02; G06T 1/00

(52) U.S. Cl. 345/589; 345/522

(57) ABSTRACT

A method comprising: producing a visual output using a user history dependent upon a plurality of past events relevant to a user of an apparatus; detecting a new event relevant to the user of the apparatus; creating a new user history dependent upon the plurality of past events relevant to a user of an apparatus and the new event relevant to the user of the apparatus; and producing a new visual output using the new user history.

### TECHNOLOGICAL FIELD

Embodiments of the present invention relate to controlling an appearance of an apparatus.

### BACKGROUND

Typically electronic apparatus are mass produced and are designed to be the same.

It can be difficult or time-consuming for a user to differentiate their apparatus from apparatuses owned by others.

A user may perhaps personalize the apparatus by, for example, selecting a personal photograph as a background to a display or as a screen saver.

However, this may require that the user is confident in manually changing settings of the apparatus.

### BRIEF SUMMARY

According to various, but not necessarily all, embodiments of the invention there is provided a method comprising: producing a visual output using a user history dependent upon a plurality of past events relevant to a user of an apparatus; detecting a new event relevant to the user of the apparatus; creating a new user history dependent upon the plurality of past events relevant to a user of an apparatus and the new event relevant to the user of the apparatus; and producing a new visual output using the new user history.

Embodiments of the invention therefore enable the automatic personalization of the apparatus. The apparatus of a user assumes a brand particular to that user and it enables the user to differentiate their apparatus from apparatuses owned by others.

According to various, but not necessarily all, embodiments of the invention there is provided an apparatus comprising: an event detection module configured to detect a new event relevant to a user of the apparatus; a user history module configured to manage a user history dependent upon a plurality of past events relevant to a user of an apparatus; and a visual output module configured to produce a visual output dependent upon the user history.

According to various, but not necessarily all, embodiments of the invention there is provided an apparatus comprising: at least one processor; and at least one memory including computer program code the at least one memory and the computer program code configured to, with the at least one processor, cause the apparatus at least to perform producing a visual output using a user history dependent upon a plurality of past events relevant to a user of an apparatus; detecting a new event relevant to the user of the apparatus; creating a new user history dependent upon the plurality of past events relevant to a user of an apparatus and the new event relevant to the user of the apparatus; and producing a new visual output using the new user history.

### BRIEF DESCRIPTION

For a better understanding of various examples of embodiments of the present invention reference will now be made by way of example only to the accompanying drawings in which:

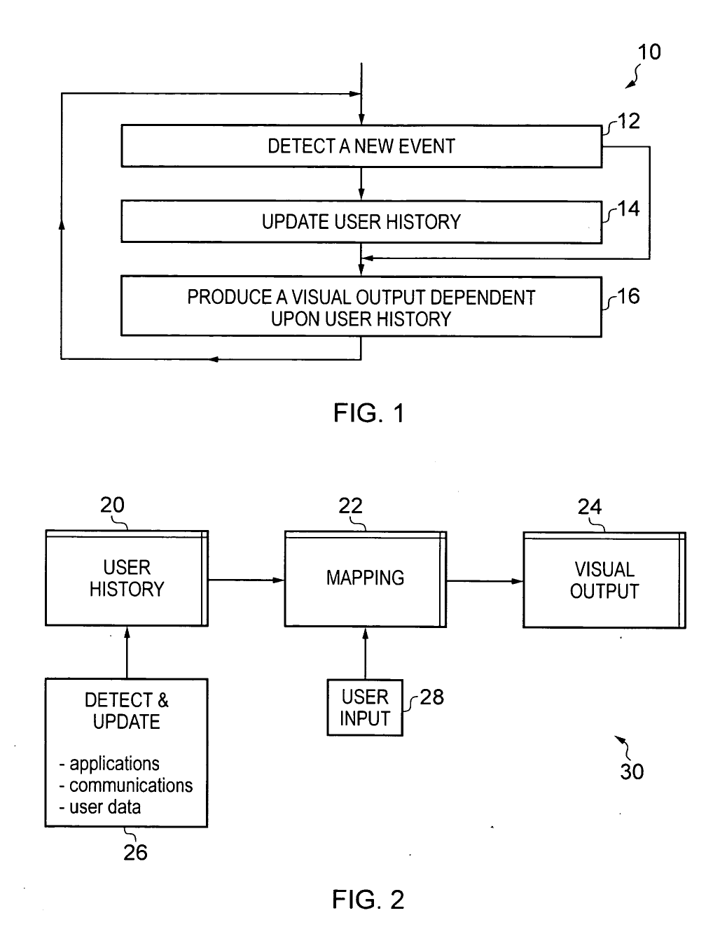

FIG. 1 illustrates an example of a method for controlling automatically a visual output of an apparatus;

FIG. 2 illustrates schematically an example of how a user history may be mapped by a mapping to produce a visual output;

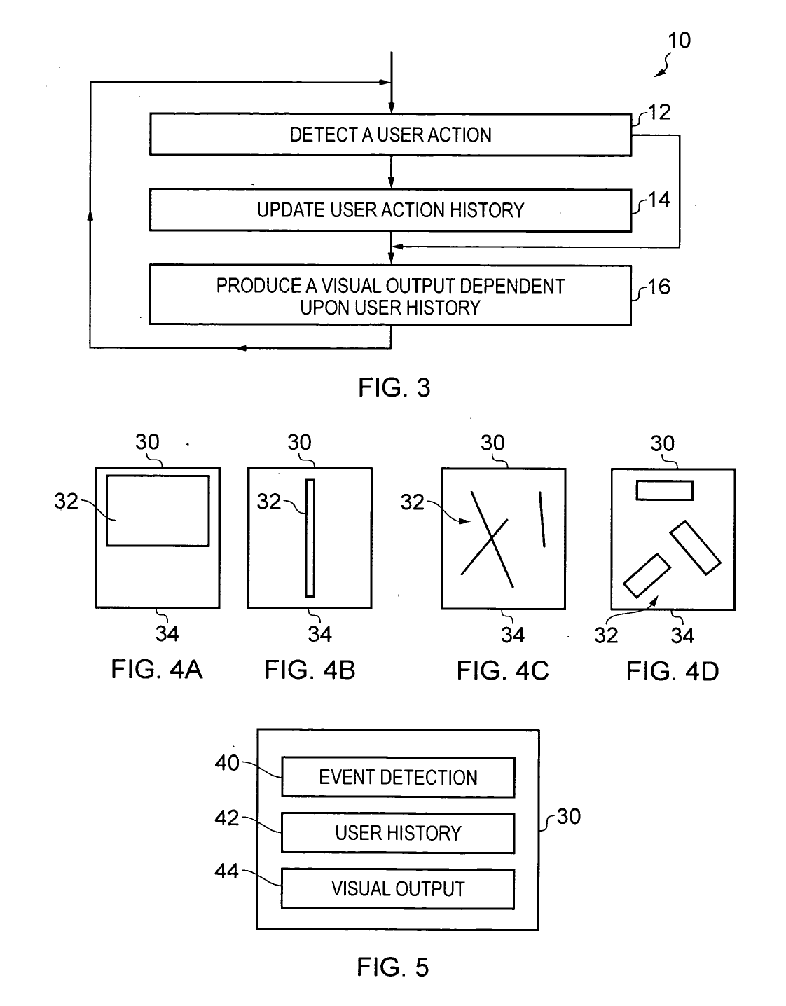

FIG. 3 illustrates a particular embodiment of the method illustrated in FIG. 1;

FIGS. 4A, 4B, 4C and 4D illustrate a non-exhaustive selection of different possible visual outputs;

FIG. 5 illustrates an example of the apparatus; and

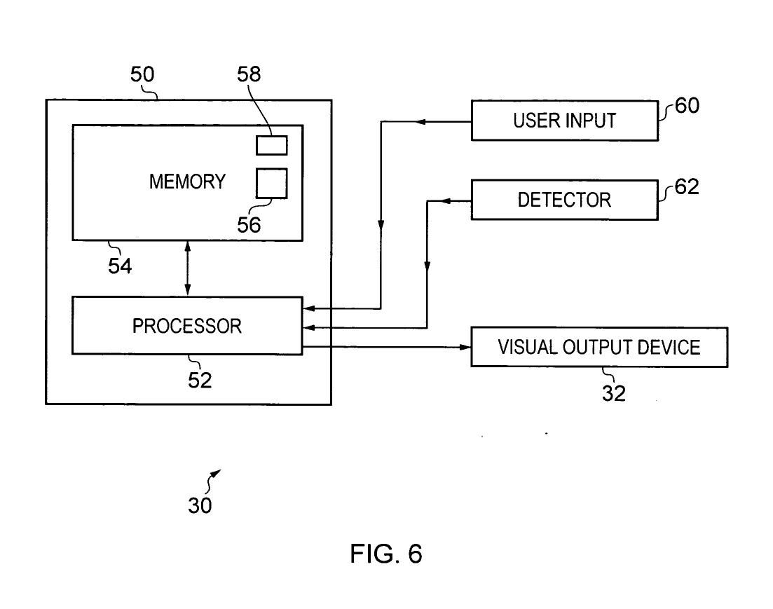

FIG. 6 illustrates another example of the apparatus.

### DETAILED DESCRIPTION

FIG. 1 illustrates an example of a method 10 for controlling a visual output of an apparatus. The visual output may be both personally meaningful to a user and aesthetic. A visual output is an output that may be perceived visually by a human user.

Referring to FIG. 1, the method 10 enables the continuous production of a visual output 24, however, the visual output changes when a user history changes.

A user history 20 is dependent upon a plurality of past events relevant to a user of an apparatus 30. The past events have occurred while the apparatus 30 has been used by the user.

Referring to FIG. 1, at block 12, the method 10 detects a new event relevant to the user of the apparatus 30.

One example of an event is an action performed by the user on the apparatus 30. Another alternative example of an event is an action performed by the user that the apparatus 30 detects from data stored by, transmitted by or received by the apparatus 30.

Next at block 14, the method 10 updates the user history 20. A new replacement user history 20 is created that is dependent upon the current user history (the plurality of past events relevant to a user of an apparatus 30) augmented by the new event relevant to the user of the apparatus 30.

Next at block 16, the method 10 produces a new visual output 24 using the new user history 20.

The method 10, after block 16, then returns to block 12.

At block 12, if a new event is detected the method 10 moves to block 14 to update the user history 20 which changes the visual output 24. However, if a new event is not detected the method 10 moves to block 16. The user history 20 is not updated and the visual output 24 is not changed.

The method 10 therefore continuously produces a visual output 24 that changes as the user history 20 changes. The visual output 24 is a continuous output that personalizes the apparatus 30 and enables differentiation of the apparatus 30 from other similar apparatus 30.

FIG. 2 illustrates schematically an example of how a user history 20 may be mapped by a mapping 22 to produce a visual output 24.

The mapping 22 may be determined by mapping parameters that control how a user history 20 determines a visual output 24. Many different mappings are possible and further details are given below.

In some examples, a user input 28 may be used to define initially the mapping parameters 22. This allows a user to control how a user history 20 determines a visual output 24.

In some examples, the user history 20 can only be augmented and cannot be reset. In this example the user may only be able to control the visual output 24 by automatic augmentation of the user history 20, for example, by using the apparatus 30. The visual output 24 may be continuously produced when the apparatus 30 is operational such that the user history 20 always affects an appearance of the apparatus 30. Thus the past user history 20 marks or brands the appearance of the apparatus 30 but in a manner that evolves dynamically with use of the apparatus 30.

The user history 20 may be updated automatically 26 when a new event relevant to the user of the apparatus is detected.

The user history 20 may be, for example, a user action history that is dependent upon a plurality of past actions performed by the user in relation to the apparatus 30. The user action history 20 records how the apparatus 30 has been used.

For example, the user action history 20 may be a data structure that records software application use. It may, for example, record what applications have been used, how often they have been used, and how they have been used.

The user action history 20 may record usage pattern and intensity. For example, the user action history 20 may be a data structure that is additionally or alternatively dependent upon a usage pattern for different communication types (e.g. voice, text, data).

For example, the user action history 20 may be a data structure that is additionally or alternatively dependent upon an analysis of user communication content. The content of user communications may, for example, be analysed to identify a user's emotion. For example, voice communications may be analysed to determine a volume and pitch of a user's speaking voice. For example, written communications may be analysed to identify emotive words.

For example, the user action history 20 may be a data structure that is additionally or alternatively dependent upon how the apparatus 30 has been augmented with software. The user action history 20 may, for example, depend upon how many applications have been installed by a user, what type of applications have been installed by a user and how recently applications have been installed by a user.

For example, the user action history 20 may be a data structure that is additionally or alternatively dependent upon where the apparatus 30 has been used. The user action history 20 may, for example, depend upon positions of the apparatus 30 determined by navigation software or systems such as Global Positioning System (GPS).

The user history 20 may, for example, be a data structure that is additionally or alternatively dependent upon user data. The user data may, for example, be content accessed by a user, calendar activities stored in a calendar on the apparatus 30 or important life events recorded in the apparatus 30 (e.g. marriage, birth, etc).

The mapping 22 of the user history 20 to the visual output 24 produces a visual output 24 that varies with time and use of the apparatus 30.

The visual output 24 may be a spatially distributed visual output. The spatial distribution of color in the visual output 24 may, for example, be controlled in dependence upon the user history 20 according to the mapping 22. The spatial distribution of brightness in the visual output 24 may, for example, be controlled in dependence upon the user history 20 according to the mapping 22.

In some embodiments, the brightness of the visual output 24 may be set to a high level whenever the user history 20 is updated. However, the brightness may automatically decrease with time. Thus if the user augments their user history 20 by using the apparatus 30 then the visual output 24 dynamically changes and remains bright. However, if the user does not use the apparatus 30 and their user history 20 is not augmented, then the visual output 24 has a brightness that continues to reduce with time. In this example, brightness reflects activity of the user.

Further aspects of some examples of the visual output 24 are discussed in more detail below, after the description relating to FIG. 3.

FIG. 3 illustrates a particular embodiment of the method 10 illustrated in FIG. 1. In this embodiment, the user history 20 is a user action history dependent upon a plurality of past actions performed by the user in relation to the apparatus.

The method 10 comprises:

a) producing at block 16 a visual output 24 using a user action history 20 dependent upon a plurality of past actions performed by the user in relation to the apparatus 30;

b) detecting, at block 12, a new action performed by the user in relation to the apparatus 30;

c) creating, at block 14, a new user action history 20 dependent upon the plurality of past actions performed by the user in relation to the apparatus 30 and the new action performed by the user in relation to the apparatus 30; and

d) producing, at block 16, a new visual output 24 using the new user action history 20.

In some but not necessarily all embodiments, the visual output 24 is completely non-alphanumeric and non-descriptive.

In some but not necessarily all embodiments, the visual output 24, does not identify explicitly any of the user history 20 or the events that comprise the user history 20.

In some but not necessarily all embodiments, the visual output 24 comprises feature(s) that are caused by particular event(s) but do not explicitly identify the event(s). The user can associate a feature with an event because, as user of the apparatus 30, he is aware from his own experience that the event caused the feature. However, another person observing the apparatus may be aware of the feature but is unaware of that causal relationship and therefore cannot associate the feature with the event. This implicit association between the feature in the visual output 24 and the event through the user's experience of causality between the event and feature provides security, as it prevents another person obtaining information about the event by observing the feature. Thus features of the visual output 24 may provide ‘addresses’ to the experiences of the user that have validity and meaning only to that user. To help explain this concept further, one of many different possible examples of implementing this concept will be explained: In this example, an email is received from a girlfriend ending a relationship. This new event causes a new user history to be created automatically, which results in the automatic production of a new visual output 24. In this example, the new visual output 24 may be an image of a visible crack, in a ‘painfully’ red shade similar to a fresh cut. The visible crack may remain as a permanent fixture or may change color and/or brightness over time simulating healing of the cut. As another example, scratches might be produced by heavy mechanical impact on the apparatus 30, detected e.g. by extreme readings in an accelerometer. The scratches may remain as permanent fixtures or may change color and/or brightness over time.

In some embodiments the visual output 24 may be continuously produced but dynamically varied, for example, as the user history 20 varies with time and use of the apparatus 30. For example, the visual output 24 may reflect the wear and tear of the apparatus 30. For example, scratches on the exterior housing of the apparatus 30 may be generated on the exterior housing of the apparatus 30 over the years of using the apparatus 30. The visual output 24 may represent wear and usage of the apparatus 30 such that a feature of the visual output 24 may vary depending on context e.g. depending on the duration of an event that causes the feature. As an example, an emotive telephone conversation may cause a new user history to be created automatically, which results in the automatic production of a new visual output 24. In this example, the new visual output 24 may be a scratch. The length of the scratch may depend on the duration of the telephone conversation. The color of the scratch may depend on who the telephone conversation is with. The brightness of the scratch may depend on a measure of emotional intensity of the conversation (e.g. average or peak volume and/or pitch change) and it may additionally be dependent upon the time that has elapsed since the telephone conversation.

FIGS. 4A, 4B, 4C and 4D illustrate a non-exhaustive selection of different possible visual outputs 24.

In these Figures, the visual output 24 is a spatially distributed visual output that is produced by a visual output device 32. The visual output device 32 may be located in an exterior housing of the apparatus 30. In these examples it is located on a housing cover 34 of the apparatus 30.

The exterior cover 34 of the apparatus 30 may be a replaceable. The exterior cover 34 of the apparatus 30 may be interchangeable with a different exterior cover 34 having a different visual output device 32. In some embodiments the cover may be non-replaceable.

In some embodiments the distribution of color in the visual output 24 produced by the visual output device 32 may be dependent upon the user history 20.

In some embodiments the brightness of the visual output 24 produced by the visual output device 32 may be dependent upon the user history 20. For example, brightness may reflect activity of the user and decay over time in the absence of use of the apparatus 30 by the user.

FIG. 4A illustrates an example where the visual output device 32 is a main display of the apparatus 30. The display 30 is used by the apparatus 30 to present, for example, alphanumeric information to a user and, in this embodiment, is additionally re-used to present the visual output 24 as a background to the display.

FIG. 4B illustrates an example where the visual output device 32 is an output device dedicated for use as the visual output device 32.

The visual output 24 is provided in a straight line as a column of light emitting elements. In some embodiments red-green-blue pixels are arranged in groups spatially distributed along the straight line. This enables the apparatus 30 to create different colors, with different brightness, at different parts of the straight line. The visual output device 32 may reside in the exterior of the apparatus 30, in the back side, front side, or on the sides or in the sides of the apparatus 30, or inside a cover of the apparatus 30 and/or the like. The visual output 24 may be created on the exterior housing of the apparatus 30. For example with nano-technologies the exterior of the apparatus 30 could show the output based on an event taken place.

FIG. 4C illustrates an example where the visual output device 32 is an output device dedicated for use as the visual output device 32. In this embodiment, the visual output device 32 is distributed over an area of the cover 34. The visual output 24 simulates scratches.

FIG. 4D illustrates an example where the visual output device 32 is an output device dedicated for use as the visual output device 32. In this embodiment, the visual output device 32 is distributed over an area of the cover 34. The visual output 24 comprises selected content relating to recent use of the apparatus by the user. For example, initially at the start of the day there may be no selected content. However, as the day progresses and the user creates or consumes content, samples of that content may be selected and incorporated into the visual output 24.

In one example embodiment, the visual output 24 is dependent upon handling and touching of the apparatus 30. For example, the pressure of the user's holding of the apparatus 30 may be reflected in the visual output 24. The lighter the touch or grip of the user the lighter the visual output 24. A harder grip may produce darker output. Artificial scratches may also be generated based on the handling of the apparatus 30 mimicking the wear of the apparatus 30. In a deformable apparatus 30, the visual output 24 may depend on the way the apparatus 30 is bent, twisted and/or otherwise handled.

FIG. 5 illustrates an example of the apparatus 30.

In this example, the apparatus 30 comprises:

a) an event detection module 40 configured to detect a new event relevant to a user of the apparatus 30;

b) a user history module 42 configured to manage a user history 20 dependent upon a plurality of past events relevant to a user of an apparatus 30; and

c) a visual output module 44 configured to produce a visual output dependent upon the user history 20.

The event detection module 40 may be provided in hardware, software or a combination of hardware and software.

The user history module 42 may be provided in hardware, software or a combination of hardware and software.

FIG. 6 illustrates an example of an apparatus 20 as illustrated in FIG. 5. In this example, a controller 50 is used to provide the event detection module 40 and the user history module 42.

Implementation of the controller 50 can be in hardware alone (a circuit, a processor . . . ), have certain aspects in software including firmware alone or can be a combination of hardware and software (including firmware).

The controller 50 may be implemented using instructions that enable hardware functionality, for example, by using executable computer program instructions in a general-purpose or special-purpose processor that may be stored on a computer readable storage medium (disk, memory etc) to be executed by such a processor.

The controller 50, in this example, comprises a processor 52 and a memory 54.

The processor 52 is configured to read from and write to the memory 54. The processor 52 may also comprise an output interface via which data and/or commands are output by the processor 52 and an input interface via which data and/or commands are input to the processor 52.

The memory 54 stores a computer program 56 comprising computer program instructions that control the operation of the apparatus 30 when loaded into the processor 52. The computer program instructions 56 provide the logic and routines that enables the apparatus to perform the methods illustrated in FIGS. 1, 2, 3 and 4. The processor 52 by reading the memory 54 is able to load and execute the computer program 56.

The computer program may arrive at the apparatus 30 via any suitable delivery mechanism . The delivery mechanism may be, for example, a non-transitory computer-readable storage medium, a computer program product, a memory device, a record medium such as a compact disc read-only memory (CD-ROM) or digital versatile disc (DVD), an article of manufacture that tangibly embodies the computer program 56. The delivery mechanism may be a signal configured to reliably transfer the computer program 56. The apparatus 30 may propagate or transmit the computer program 56 as a computer data signal.

Although the memory 54 is illustrated as a single component it may be implemented as one or more separate components some or all of which may be integrated/removable and/or may provide permanent/semi-permanent/dynamic/cached storage.

The apparatus 30 therefore comprises: at least one processor 52; and at least one memory 54 including computer program code 56 the at least one memory 54 and the computer program code 56 configured to, with the at least one processor 52, cause the apparatus 30 at least to perform:

a) producing a visual output 24 using a user history 20 dependent upon a plurality of past events relevant to a user of an apparatus 30;

b) detecting a new event relevant to the user of the apparatus 30;

c) creating a new user history 20 dependent upon the plurality of past events relevant to a user of an apparatus 30 and the new event relevant to the user of the apparatus 30; and

d) producing a new visual output 24 using the new user history 20.

The memory 54 may additionally store a data structure 58 that records the user history 20, the visual output 24 and the mapping 22 for mapping the user history 20 to the visual output 24.

The apparatus 30 may additionally comprise a user input device 60. In some embodiments the user input device 60 is used by a user to perform actions that cause automatic augmentation of the user history 20. In some embodiments the user input device 60 may be used by a user to initially define the mapping 22. The user input device 60 may be for example a touch screen keypad, a touch screen, a hardware keypad, a touch pad, a hovering sensing device, a pressure sensing device and/or the like. The apparatus 30 may be a one-body, multiple-body device, a tablet, a flexible, a deformable device and/or the like.

The apparatus 30 may additionally comprise a hardware detector 62. In some embodiments the hardware detector 62 is used to detect a new event relevant to the user of the apparatus that augments the user history 20. In some embodiments, the hardware detector 62 may be an impact detector that detects when the apparatus 30 impacts another object. For example, an accelerometer may be used as an impact detector that detects accelerating/decelerating impulses.

In some embodiments, a history of impacts may be stored and used to control the simulation of scratches via the visual output 24 (FIG. 4C).

The apparatus 30 comprises a visual output device 32. In some embodiments the visual output 24 is provided using a low power display, a light array, a plurality of light emitting diodes, or an electronic ink display.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.”

The blocks illustrated in the FIGS. 1, 2 and 3 may represent steps in a method and/or sections of code in the computer program 56. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method comprising:
producing a visual output using a user history dependent upon a plurality of past events relevant to a user of an apparatus;
detecting a new event relevant to the user of the apparatus;
creating a new user history dependent upon the plurality of past events relevant to a user of an apparatus and the new event relevant to the user of the apparatus; and
producing a new visual output using the new user history.

2. A method as claimed in claim 1, wherein the new visual output is a continuous output that personalizes the apparatus and enables differentiation of the apparatus from other similar apparatus.

3. A method as claimed in claim 1, wherein the user defines parameters that control how a user history determines a visual output.

4. A method as claimed in claim 1, wherein the user history can be augmented but cannot be reset, and wherein a visual output is continuously produced when the apparatus is operational such that the user history always affects an appearance of the apparatus.

5. A method as claimed in claim 1, wherein the user history is a user action history dependent upon a plurality of past actions performed by the user in relation to the apparatus, the method comprising:
producing a visual output using a user action history dependent upon a plurality of past actions performed by the user in relation to the apparatus;
detecting a new action performed by the user in relation to the apparatus;
creating a new user action history dependent upon the plurality of past actions performed by the user in relation to the apparatus and the new action performed by the user in relation to the apparatus; and
producing a new visual output using the new user action history.

6. A method as claimed in claim 5, wherein the user action history is dependent upon events selected from the group comprising:
application use;
how the apparatus has been used;
usage pattern for different communication types;
analysis of user communication content;
how the apparatus has been augmented with software; and
events in a user's life.

7-11. (canceled)

12. A method as claimed in claim 1, comprising using a hardware detector to detect the new event relevant to the user of the apparatus.

13. A method as claimed in claim 1, wherein the hardware detector is an impact detector.

14. A method as claimed in claim 1, comprising producing a visual output using the user action history that varies with time and use of the apparatus.

15. (canceled)

16. A method as claimed in claim 1, wherein the visual output is a spatially distributed visual output.

17. A method as claimed in claim 16, comprising controlling distribution of color in the visual output in dependence upon the user history.

18. A method as claimed in claim 16, comprising controlling distribution of brightness in the visual output in dependence upon the user history.

19. A method as claimed in claim 18, comprising reducing brightness over time in the absence of use of the apparatus by the user.

20. A method as claimed in claim 1, comprising using the visual output to simulate scratches.

21. A method as claimed in claim 1, wherein the visual output comprises selected content relating to recent use of the apparatus by the user.

22-23. (canceled)

24. An apparatus comprising:
an event detection module configured to detect a new event relevant to a user of the apparatus;
a user history module configured to manage a user history dependent upon a plurality of past events relevant to a user of an apparatus; and
a visual output module configured to produce a visual output dependent upon the user history.

25. An apparatus as claimed in claim 24, wherein the visual output is provided in a straight line.

26. An apparatus as claimed in claim 24, wherein the visual output is provided using dedicated hardware.

27. (canceled)

28. An apparatus as claimed in claim 24, wherein the visual output is positioned on an exterior cover of the apparatus.

29-31. (canceled)

32. An apparatus comprising:
at least one processor; and
at least one memory including computer program code
the at least one memory and the computer program code configured to, with the at least one processor, cause the apparatus at least to perform
producing a visual output using a user history dependent upon a plurality of past events relevant to a user of an apparatus;
detecting a new event relevant to the user of the apparatus;
creating a new user history dependent upon the plurality of past events relevant to a user of an apparatus and the new event relevant to the user of the apparatus; and
producing a new visual output using the new user history

33. (canceled)
